(19) United States
(12) Patent Application Publication
(10) Pub. No.: US 2005/0214709 A1
(43) Pub. Date: Sep. 29, 2005

(54) Metallic archwires and dental crowns of various colors and their preparation methods

(75) Inventors: Sinn-Wen Chen, Hsinchu (TW); Chiao-Ling Yang, Hsinchu (TW)

Correspondence Address: BACON & THOMAS, PLLC, 625 SLATERS LANE, FOURTH FLOOR, ALEXANDRIA, VA, 22314, US

(73) Assignee: National Tsing Hua University, Hsinchu (TW)

(21) Appl. No.: 10/810,800

(22) Filed: Mar. 29, 2004

(51) Int. Cl. A61C 3/00; A61C 5/08

(52) U.S. Cl. 433/20; 433/218

(57) ABSTRACT

This invention provides metallic archwires or dental crowns with various colors, which can be prepared by subjecting the orthodontic archwires or metallic dental crowns to an anodizing treatment.

### FIELD OF THE INVENTION

The present invention relates to metallic archwires and dental crowns with colors different from the original metallic gloss, and a method for preparing the metallic archwires and dental crowns. The invented method includes subjecting the metallic orthodontic archwires and dental crowns to an anodizing treatment.

### BACKGROUND OF THE INVENTION

Orthodontics has become a popular dental treatment where an orthodontic archwire is one of the main materials used in this treatment. At present, common orthodontic archwires used include stainless steel wires or β-Ti and Ni—Ti shape memory alloy wires. Andreasen uses a Ni—Ti alloy in orthodontic archwires [G F. Andreasen, U.S. Pat. No. 4,037,324, (1977)], Burstone et al. are pioneers in using β-Ti material [C. J. Burstone and A. J. Goldberg, U.S. Pat. No. 4,197,643, (1980)]. Other ingredients are also introduced to form orthodontic archwires of various compositions [R. C. L. Sachdeva and F. Farzin, U.S. Pat. No. 5,683,245, (1997); K. Mitose and T. Ueki, U.S. Pat. No. 5,951,793, (1999); L. C. Schetky, M. H. Wu, C. -Y. Loi, and C. J. Burstone, U.S. Pat. No. 6,258,182, (2001); J. A. Davidson, A. K. Mishra, K. P. Daigle, and P. Kovacs, U.S. Pat. No. 5,573,401, (1996)]. Dental crowns are also commonly used for dental care. Metallic dental crowns are made either with noble metals or base metals, such as NiCr alloys.

The abovementioned orthodontic archwires and metallic crowns all have bright metallic color. For cosmetic reasons, some orthodontic archwires are transparent, or even transparent with a nano structure. For example, Lemchen recently proposed a very different mesoporous alloidal orthodontic archwire [M. S. Lemchen, U.S. Pat. No. 6,056,545, (2000)]. The mesoporous alloidal orthodontic archwire invented by Lemchen has a transparency derived from the mesoporous nature thereof; it is expected that the mechanical strength thereof is inferior to the original dense material. This is a serious restriction on the use of orthodontic archwires.

Among the techniques available currently, there is no disclosure of a colored metallic orthodontic archwire and dental crown by an anodizing treatment.

### SUMMARY OF THE INVENTION

The present invention uses an anodizing treatment to treat metallic orthodontic archwires and dental crowns in order to increase the corrosion resistance thereof, while forming a desired color thereon. The selection of a metallic material used in making the orthodontic archwires and dental crowns of the present invention is rather flexible—including a stainless steel wire with excellent properties, NiCr alloys and a shape memory alloy. Compared with the conventional orthodontic archwire and dental crown, a product according to the present invention has no conspicuous difference in mechanical properties, while having a desired color in meeting personal preferences.

### DETAILED DESCRIPTION OF THE PREFERRED EMBODIMENTS

Preferred embodiments of the present invention include (but not limited to) the followings:

1. A metallic article of an orthodontic archwire or dental crown having a color different from its original metallic gloss.

2. The metallic article as recited in Item 1, which is an orthodontic archwire.

3. The metallic article as recited in Item 2, wherein the color of said orthodontic archwire is formed by an anodizing treatment.

4. The metallic article as recited in Item 2, wherein said orthodontic archwire is made of an alloy mainly consisting of β-Ti.

5. The metallic article as recited in Item 2, wherein said orthodontic archwire is made of an alloy mainly consisting of Ni and Ti.

6. The metallic article as recited in Item 2, wherein said orthodontic archwire is made of an alloy mainly consisting of stainless steel.

7. The metallic article as recited in Item 2, wherein the color of said orthodontic archwire is blue, yellow, purple, green, golden, or tawny.

8. The metallic article as recited in Item 1, which is a dental crown.

9. The metallic article as recited in Item 8, wherein the color of said orthodontic archwire is formed by an anodizing treatment.

10. The metallic article as recited in Item 8, wherein said dental crown is made of an alloy mainly consisting of Ni and Cr.

11. The metallic article as recited in Item 8, wherein said dental crown is made of an alloy mainly consisting of Ni.

12. The metallic article as recited in Item 8, wherein said dental crown is made of an alloy mainly consisting of stainless steel.

13. The metallic article as recited in Item 8, wherein the color of said dental crown is blue, yellow, purple, green, golden, or tawny.

14. A method for preparing a colored metal article of an orthodontic archwire or dental crown, which comprises the following steps:
a) cleaning a metallic article; and
b) performing an anodizing treatment on the cleaned metallic article from step a) in order to obtain a color on the surface of said metallic article different from its original metallic gloss, wherein an electrolytic solution used in said anodizing treatment is an acidic aqueous solution.

15. The method as recited in Item 14, wherein an operation voltage of said anodizing treatment is 5 V-60 V.

16. The method as recited in Item 14, wherein said metallic article is made of an alloy mainly consisting of β-Ti, and said electrolytic solution is an aqueous solution of a sulfate.

17. The method as recited in Item 14, wherein said metallic article is made of an alloy mainly consisting of Ni and Ti, and said electrolytic solution is an aqueous solution of a sulfate.

18. The method as recited in Item 14, wherein the color on the surface of said metallic article is blue, yellow, purple, green, golden, or tawny.

19. The method as recited in Item 14, wherein said cleaning comprises immersing said metallic article in an acidic aqueous solution.

20. The method as recited in Item 19, wherein said acidic aqueous solution is an aqueous solution of hydrochloric acid.

According to one of the preferred embodiments of the present invention, a metallic orthodontic archwire with a color different from its original metallic gloss is provided.

The biocompatibility of an orthodontic archwire is very important because such an orthodontic archwire is mounted on the teeth of a person. Therefore, an ordinary dying or pigment coating technique can not be applied on the coloring of an orthodontic archwire. The coloring method of anodizing treatment according to the present invention uses the optical interference effect of the oxide film on the surface of the material without external addition of a pigment. The products resulting from the anodizing treatment are oxides of the metallic elements of the orthodontic archwire, which are formed on the surface of the orthodontic archwire. For an ordinary metal element, its oxide is often more stable than the metal element, that is the biocompatibility after anodizing treatment will become better. Therefore, the anodizing treatment will not introduce an additional biocompatibility problem. Furthermore, the anodizing treatment according to the present invention only oxidizes the surface of the material such that the mechanical strength of the orthodontic archwire will not be affected conspicuously. In other words, an anodizing treatment can alter the outlook color of an orthodontic archwire, without significantly changing the biocompatibility and mechanical strength thereof (wherein the former might be increased slightly, while the later might be decreased or increased slightly). The anodizing treatment of titanium metal has been widely elaborated in the literature (G. G. Turner, GB1100913, 1968; Shreir, GB962904, 1964; Kendull, U.S. Pat. No. 3,663,379, 1972; Kaminski, U.S. Pat. No. 6,029,390, 2000)—with a major emphasis on the titanium structural materials. Among the prior arts, there is completely no disclosure of anodizing treatment on the orthodontic archwires, as well as completely no disclosure on the anodizing treatment of Ti—Ni phase. The anodizing treatment is also applicable to dental crowns for altering the outlook color without significantly changing the biocompatibility and mechanical strength thereof.

### EXAMPLE 1

An orthodontic archwire of Ni—Ti alloy (code No. N-003, Ni—Ti orthodontic archwire from DCA Corp. of U.S.A.) was subjected to an anodizing treatment, wherein the electrolytic solution used was an aqueous solution prepared by dissolving 5 g of Na₂SO₄•10H₂O in 400 ml of water, the anode was said orthodontic archwire, the cathode was a platinum plate, and the power supply was a LPS 305 from the MOTECH Co.

Said orthodontic archwire was immersed in a 0.5 M NaOH solution and subjected to an ultrasonic oscillation for 5 minutes. This alkaline washing treatment removed esters on the surface and activated the surface of the metal in order to achieve a uniform surface property. Next, said orthodontic archwire was immersed in a hydrochloric acid solution (30 g HCl/100 ml H₂O) and subjected to an ultrasonic oscillation for 10 minutes in order to remove the oxides on the metal surface, followed by washing with a large quantity of distilled water and drying by blowing. A constant voltage was used to perform an anodizing treatment at room temperature, wherein the voltage used was 10 V, and the anodizing treatment time was 120 minutes. Next, said orthodontic archwire was removed, washed with distilled water, and dried by blowing, to obtain a blue orthodontic archwire. Said orthodontic archwire has a bright metallic gloss of Ni—Ti alloy prior to receiving the treatment.

### EXAMPLE 2

An orthodontic archwire of Ni—Ti alloy (Code No. N-003, Ni—Ti orthodontic archwire from DCA Corp. of U.S.A.) was used as a specimen. The electrolytic solution used was an aqueous solution prepared by dissolving 10 g of Na₂SO₄•10H₂O in 400 ml of water. The experiment system and method for pre-treating the specimen were identical to Example 1. The anodizing treatment was carried out at room temperature with a constant voltage. The operation voltage used was 10 V, and the anodizing treatment time was 120 minutes. Next, said specimen was removed, washed with distilled water, and dried by blowing, to obtain a yellow orthodontic archwire.

### EXAMPLE 3

An orthodontic archwire of Ni—Ti alloy (Code No. N-003, Ni—Ti orthodontic archwire from DCA Corp. of U.S.A.) was used as a specimen. The electrolytic solution used was an aqueous solution prepared by dissolving 20 g of Na₂SO₄•10H₂O in 400 ml of water. The experiment system and method for pre-treating the specimen were identical to Example 1. The anodizing treatment was carried out at room temperature with a constant voltage. The operation voltage used was 10 V, and the anodizing treatment time was 120 minutes. Next, said specimen was removed, washed with distilled water, and dried by blowing, to obtain a purple orthodontic archwire.

### EXAMPLE 4

An orthodontic archwire of Ni—Ti alloy (Code No. N-003, NiTi orthodontic archwire from DCA Corp. of U.S.A.) was used as a specimen. The electrolytic solution used was an aqueous solution prepared by dissolving 5 g of Na₂SO₄•10H₂O in 400 ml of water. The experiment system and method for pre-treating the specimen were identical to Example 1. The anodizing treatment was carried out at room temperature with a constant voltage. The operation voltage used was 20 V, and the anodizing treatment time was 120 minutes. Next, said specimen was removed, washed with distilled water, and dried by blowing, in order to obtain a blue orthodontic archwire.

### EXAMPLE 5

An orthodontic archwire of Ni—Ti alloy (Code No. N-003, NiTi orthodontic archwire from DCA Corp. of U.S.A.) was used as a specimen. The electrolytic solution used was an aqueous solution prepared by dissolving 10 g of Na₂SO₄•10H₂O in 400 ml of water. The experiment system and method for pre-treating the specimen were identical to Example 1. The anodizing treatment was carried out at room temperature with a constant voltage. The operation voltage used was 20 V, and the anodizing treatment time was 120 minutes. Next, said specimen was removed, washed with distilled water, and dried by blowing, in order to obtain a green orthodontic archwire.

### EXAMPLE 6

A β-Ti orthodontic archwire (Code No. 100-942, β-Ti orthodontic archwire from INC Corp. of U.S.A.) was used as a specimen. The electrolytic solution used was an aqueous solution prepared by dissolving 10 g of Na₂SO₄•10H₂O in 400 ml of water. The experiment system and method for pre-treating the specimen were identical to Example 1. The anodizing treatment was carried out at room temperature with a constant voltage. The operation voltage used was 60 V, and the anodizing treatment time was 5 minutes. Next, said specimen was removed, washed with distilled water, and dried by blowing, to obtain a purple orthodontic archwire.

### EXAMPLE 7

A β-Ti orthodontic archwire (Code No. 100-942, β-Ti orthodontic archwire from INC Corp. of U.S.A.) was used as a specimen. The electrolytic solution used was an aqueous solution prepared by dissolving 10 g of Na₂SO₄•10H₂O in 400 ml of water. The experiment system and method for pre-treating the specimen were identical to Example 1. The anodizing treatment was carried out at room temperature with a constant voltage. The operation voltage used was 40 V, and the anodizing treatment time was 5 minutes. Next, said specimen was removed, washed with distilled water, and dried by blowing,. to obtain a golden orthodontic archwire.

### EXAMPLE 8

A β-Ti orthodontic archwire (Code No. 100-942, β-Ti orthodontic archwire from INC of U.S.A.) was used as a specimen. The electrolytic solution used was an aqueous solution prepared by dissolving 10 g of Na₂SO₄•10H₂O in 400 ml of water. The experiment system and method for pre-treating the specimen were identical to Example 1. The anodizing treatment was carried out at room temperature with a constant voltage. The operation voltage used was 20 V, and the anodizing treatment time was 5 minutes. Next, said specimen was removed, washed with distilled water, and dried by blowing, to obtain a blue orthodontic archwire.

### EXAMPLE 9

A β-Ti orthodontic archwire (Code No. 100-942, β-Ti orthodontic archwire from INC Corp. of U.S.A.) was used as a specimen. The electrolytic solution used was an aqueous solution prepared by dissolving 10 g of Na₂SO₄•10H₂O in 400 ml of water. The experiment system and method for pre-treating the specimen were identical to Example 1. The anodizing treatment was carried out at room temperature with a constant voltage. The operation voltage used was 10 V, and the anodizing treatment time was 5 minutes. Next, said specimen was removed, washed with distilled water, and dried by blowing, to obtain a tawny orthodontic archwire.

### EXAMPLE 10

A NiCr dental crown was used as a specimen. The electrolytic solution used was an aqueous solution prepared by dissolving 5 g of Na₂SO₄•10H₂O in 400 ml of water. The experiment system and method for pre-treating the specimen were identical to Example 1. The anodizing treatment was carried out at room temperature with a constant voltage. The operation voltage used was 5 V, and the anodizing treatment time was 30 minutes. Next, said specimen was removed, washed with distilled water, and dried by blowing, in order to obtain a slight bronze color.

1. A metallic article of an orthodontic archwire or dental crown having a color different from its original metallic gloss.

2. The metallic article as claimed in claim 1, which is an orthodontic archwire.

3. The metallic article as claimed in claim 2, wherein the color of said orthodontic archwire is formed by an anodizing treatment.

4. The metallic article as claimed in claim 2, wherein said orthodontic archwire is made of an alloy mainly consisting of β-Ti.

5. The metallic article as claimed in claim 2, wherein said orthodontic archwire is made of an alloy mainly consisting of Ni and Ti.

6. The metallic article as claimed in claim 2, wherein said orthodontic archwire is made of an alloy mainly consisting of stainless steel.

7. The metallic article as claimed in claim 2, wherein the color of said orthodontic archwire is blue, yellow, purple, green, golden, or tawny.

8. The metallic article as claimed in claim 1, which is a dental crown.

9. The metallic article as claimed in claim 8, wherein the color of said orthodontic archwire is formed by an anodizing treatment.

10. The metallic article as claimed in claim 8, wherein said dental crown is made of an alloy mainly consisting of Ni and Cr.

11. The metallic article as claimed in claim 8, wherein said dental crown is made of an alloy mainly consisting of Ni.

12. The metallic article as claimed in claim 8, wherein said dental crown is made of an alloy mainly consisting of stainless steel.

13. The metallic article as claimed in claim 8, wherein the color of said dental crown is blue, yellow, purple, green, golden, or tawny.

14. A method for preparing a colored metal article of an orthodontic archwire or dental crown, which comprises the following steps:
a) cleaning a metallic article; and
b) performing an anodizing treatment on the cleaned metallic article from step a) in order to obtain a color on the surface of said metallic article different from its original metallic gloss, wherein an electrolytic solution used in said anodizing treatment is an acidic aqueous solution.

15. The method as claimed in claim 14, wherein an operation voltage of said anodizing treatment is 5 V-60 V.

16. The method as claimed in claim 14, wherein said metallic article is made of an alloy mainly consisting of β-Ti, and said electrolytic solution is an aqueous solution of a sulfate.

17. The method as claimed in claim 14, wherein said metallic article is made of an alloy mainly consisting of Ni and Ti, and said electrolytic solution is an aqueous solution of a sulfate.

18. The method as claimed in claim 14, wherein the color on the surface of said metallic article is blue, yellow, purple, green, golden, or tawny.

19. The method as claimed in claim 14, wherein said cleaning comprises immersing said metallic article in an acidic aqueous solution.

20. The method as claimed in claim 19, wherein said acidic aqueous solution is an aqueous solution of hydrochloric acid.
